(19) United States
(12) Patent Application Publication
(10) Pub. No.: US 2012/0272059 A1
(43) Pub. Date: Oct. 25, 2012

(54) SYSTEM AND METHOD FOR SECURE EXCHANGE OF INFORMATION IN A COMPUTER SYSTEM

(76) Inventors: VARUN SHETTY, Bangalore (IN); Chethan Suresh, Bangalore (IN); Shridhar Doddamatekurke Gangadharappa, Bangalore (IN)

(21) Appl. No.: 13/090,258

(22) Filed: Apr. 20, 2011

(51) Int. Cl. H04L 9/00

(52) U.S. Cl. 713/164; 713/150

(57) ABSTRACT

A system and method for secure exchange of information in a computing system is described. In one embodiment, the method includes receiving a request to switch to a safe mode from a target application. Encryption/decryption keystring is generated based on the request. The target application is responded with the decryption keystring. A key-stroke is encrypted using the encryption keystring. The encrypted key-stroke is stored in a keyboard buffer. The target application retrieves the encrypted key-stroke and decrypts the encrypted key-stroke using the decryption keystring.

### FIELD OF TECHNOLOGY

Embodiments of the present invention relate to secure exchange of information in a computing system. More particularly, embodiments of the present invention relate to secure exchange of keystroke information between a kernel and an application in a computing system.

### BACKGROUND

In a computing system, a kernel of the computing system communicates with various applications running on the computing system. For example, keystroke information received from a keyboard is made available by the kernel to various applications registered to receive the keystroke information. Kernel stores the keystroke information in a keyboard buffer that is accessible to various applications registered to receive the keystroke information. Sometimes, one or more malicious applications may register with the kernel to receive keystroke information. Oftentimes, these malicious applications are referred to as keylogger applications. As one skilled in the art appreciates, some of the keystroke information made available may be sensitive information, for example, information like account information and password information.

Existing techniques may not efficiently protect sensitive information from being accessed by malicious or unauthorized applications. For example, keylogger applications.

### SUMMARY

A system and method for secure exchange of information in a computing system is described. In one embodiment, the method includes receiving a request to switch to a safe mode from a target application. Encryption/decryption keystring is generated based on the request. The target application is responded with the decryption keystring. A key-stroke is encrypted using the encryption keystring. The encrypted key-stroke is stored in a keyboard buffer. The target application retrieves the encrypted key-stroke and decrypts the encrypted key-stroke using the decryption keystring.

In yet another embodiment, a system for secure exchange of information in a computing system is disclosed. The system includes a kernel module configured to receive a request to switch to a safe mode from a target application. The kernel module generates an encryption/decryption keystring based on the received request. The kernel module further responds to the target application with the decryption keystring. A key-stroke is encrypted using the encryption keystring and the encrypted key-stroke is stored in a keyboard buffer. The target application is configured to retrieve the encrypted key-stroke from the keyboard buffer; and decrypt the encrypted key-stroke using the decryption keystring.

In yet another embodiment, a non-transitory computer readable storage medium for secure exchange of information in a computing system is provided. The storage medium has instructions that, when executed by a computing device causes the computing device to perform the method as disclosed above.

### BRIEF DESCRIPTION OF THE DRAWINGS

Various preferred embodiments are described herein with reference to the drawings, wherein:

FIG. 1 illustrates an exemplary computing system, according to an embodiment of this disclosure;

FIG. 2 illustrates a logical view of the computing system, according to an embodiment of this disclosure;

FIG. 3 illustrates a block diagram of the internal functional architecture of the system hardware, according to one aspect of the present disclosure;

FIG. 4 illustrates an exemplary block diagram showing the processing of a key-stroke by the exemplary computing system of FIG. 1, according to an embodiment of this disclosure; and

FIG. 5 illustrates a method for secure exchange of information in a computing system, according to an embodiment of this disclosure.

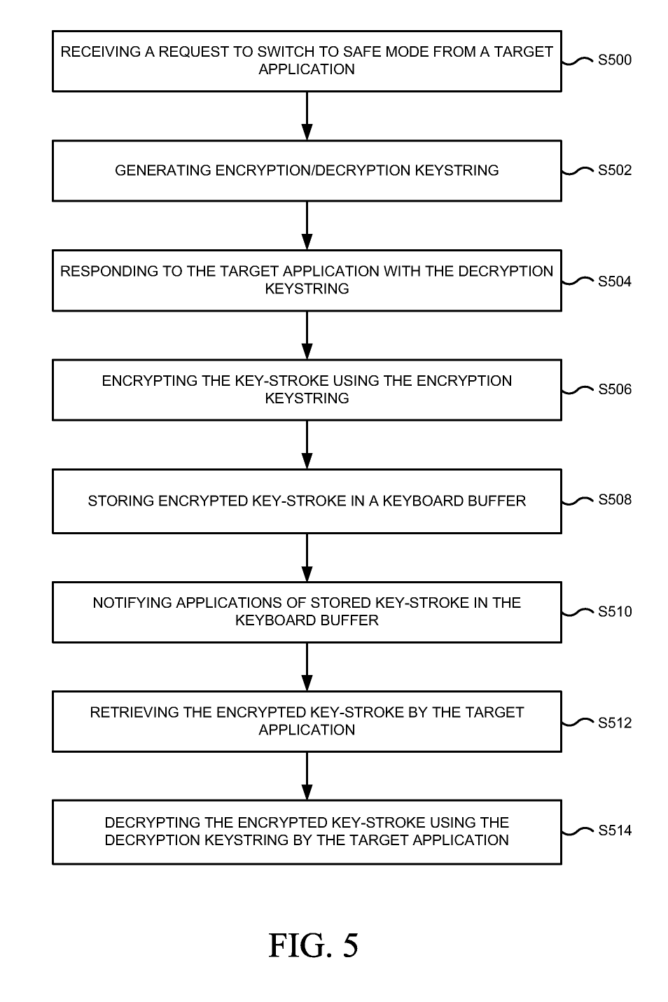

The drawings described herein are for illustration purposes only and are not intended to limit the scope of the present disclosure in any way.

### DETAILED DESCRIPTION

Systems and method for secure exchange of information in a computing system are disclosed. In the following detailed description of the embodiments of the disclosure, reference is made to the accompanying drawings that form a part hereof, and in which are shown by way of illustration specific embodiments in which the invention may be practiced. These embodiments are described in sufficient detail to enable those skilled in the art to practice the disclosure, and it is to be understood that other embodiments may be utilized and that changes may be made without departing from the scope of the present disclosure. The following detailed description is, therefore, not to be taken in a limiting sense, and the scope of the present disclosure is defined only by the appended claims.

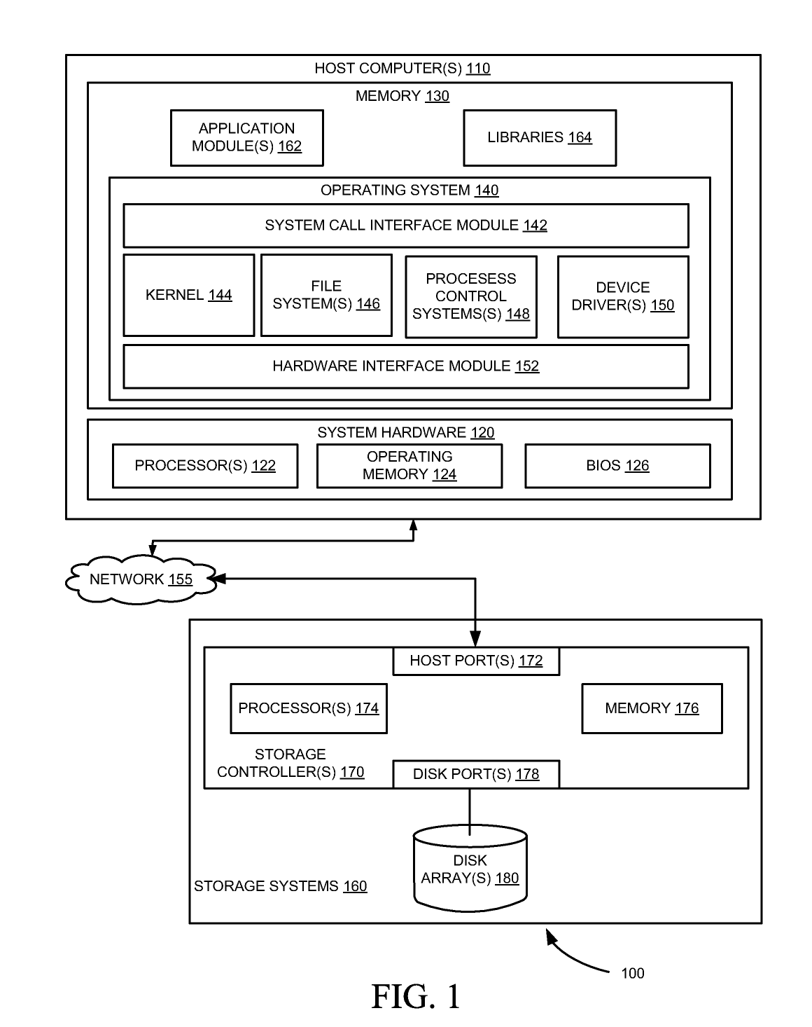

More particularly, FIG. 1 is a schematic illustration of components of a computing system 100 in accordance with some embodiments. The computing system 100 may include one or more host computers 110 coupled to one or more storage systems 160 via a communication network 155.

Host computer(s) 110 may include system hardware 120 commonly implemented on a motherboard and in some instances, with one or more auxiliary circuit boards. System hardware 120 includes, among other things, one or more processors 122 and a basic input/output system (BIOS) 126. BIOS 126 may be implemented in flash memory and may comprise logic operations to boot the computer device and a power-on self-test (POST) module for performing system initialization and tests. In operation, when activation of computing system 100 begins, processor 122 accesses BIOS 126 and shadows the instructions of BIOS 126, such as power-on self-test module, into operating memory 124. Processor 122 then executes power-on self-test operations to implement POST processing.

Host computer 110 further includes memory 130, which may be implemented as random access memory (RAM), dynamic random access memory (DRAM), read-only memory (ROM), magnetic memory, optical memory, or combinations thereof. Memory 130 includes an operating system 140 for managing operations of computer 110. In one embodiment, operating system 140 includes a hardware interface module 154 that provides an interface to system hardware 120. In addition, operating system 140 includes a kernel 144 (sometimes referred to as kernel module 144), one or more file systems 146 that manage files used in the operation of computer 110 and a process control subsystem 148 that manages processes executing on computer 110.

Operating system 140 further includes one or more device drivers 150 and a system call interface module 142 that provides an interface between the operating system 140 and one or more application modules 162 and/or libraries 164. The various device drivers 150 interface with and generally control the hardware installed in the computing system 100.

In operation, one or more application modules 162 and/or libraries 164 executing on a computer make calls to the system call interface module 142 to execute one or more commands on the computer's processor. The system call interface module 142 invokes the services of the file systems 146 to manage the files required by the command(s) and the process control subsystem 148 to manage the process required by the command(s). The file system(s) 146 and the process control subsystem 148, in turn, invoke the services of the hardware interface module 154 to interface with the system hardware 120. The operating system kernel 144 may be generally considered as one or more software modules that are responsible for performing many operating system functions.

The particular embodiment of operating system 140 is not critical to the subject matter described herein. Operating system 140 may be embodied as a UNIX operating system or any derivative thereof (e.g., Linux, Solaris, etc.) or as a Windows brand operating system. Computer system 110 may include one or more accompanying input/output devices such as, e.g., a display, a keyboard, and a mouse, and the like.

Storage system 160 generally comprises one or more storage controllers 170 coupled to one or more disk arrays 180, or other storage media. Storage controller 170 manages input/output (I/O) requests from host computer(s) 110 for storing and retrieving information on one or more disk arrays 180. Storage controller 170 may include one or more host ports 172 that couple to network 155 to provide a communication interface with host computer(s) 110. Host ports 172 may include appropriate logic for interfacing with attached host computer(s) 110 via appropriate protocols and media associated with communication network 155. In some embodiments, communication network 155 may utilize peripheral component interconnect (PCI), PCI-X, PCI express (PCIe), other parallel bus structures, and high speed serial interface communication paths (such as SAS) or the like to facilitate communication between the storage system 160 and the host computer 110.

Storage controller 170 may also include one or more disk port(s) 178 which provide an interface for interacting with attached disk arrays 180. Disk ports 178 may operate according to Fibre Channel, parallel SCSI, other parallel bus structures, and other high speed serial communication media and protocols (such as SATA and/or SAS). Disk ports 178 therefore represent any of several commercially available interface elements for exchanging information with attached disk arrays 180.

Storage controller 170 may include one or more processors 174 to control operations of storage controller 170. For example, the processor(s) 174 may fetch and execute programmed instructions as well as associated variables from program memory 176. Memory 176 may be any suitable memory device for storing programmed instructions and/or associated data to be executed or manipulated by processor 174 including, for example, ROM, PROM, EPROM, flash memory, RAM, DRAM, SDRAM, etc. A direct memory access (DMA) controller may effectuate transfers between elements of the controller 170.

Those of ordinary skill in the art will recognize a wide variety of equivalent structures to that of computing system 100 of FIG. 1 to provide features and aspects hereof.

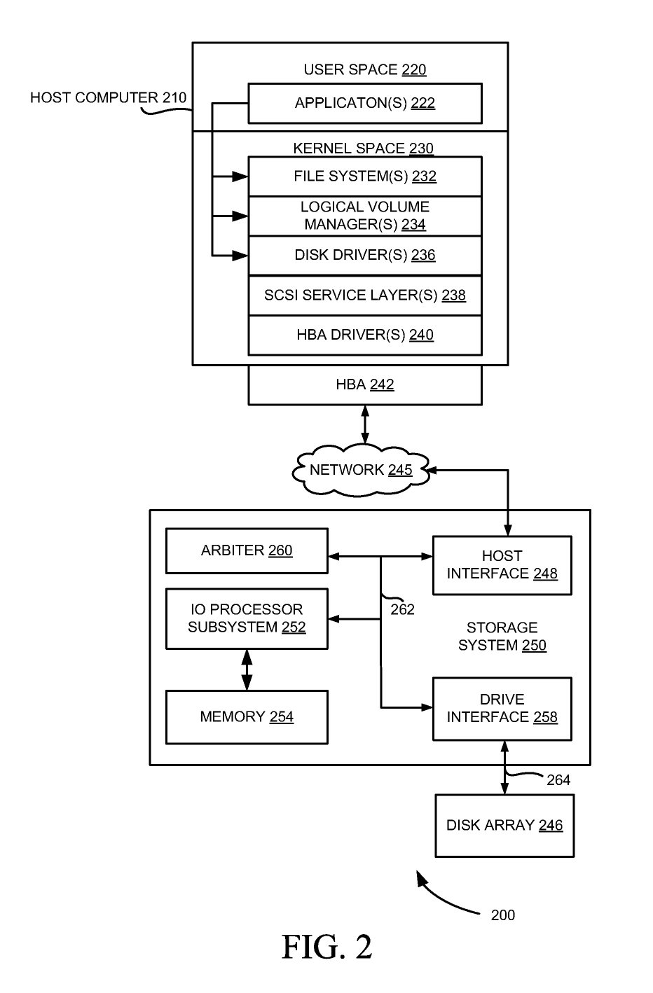

FIG. 2 is a schematic illustration of a logical view of a computing system 200 in accordance with some embodiments. The host computer 210 depicted in FIG. 2 may correspond to the host computer 110 depicted in FIG. 1. Similarly, the storage system 250 depicted in FIG. 2 may correspond to storage system 160 depicted in FIG. 1.

As shown in FIG. 2, one or more applications 222 execute in the user space 220 of the operating system of host computer system 210. The kernel space 230 of host computer 210 comprises one or more file system(s) 232, logical volume manager(s) 234, disk driver(s) 236, SCSI services layer(s) 238, and host bus adapter driver(s) 240. A host bus adapter 242 couples the host computer 210 to disk array 246 (which may correspond to the disk array 180 of FIG. 1 in an embodiment), using network 245 and storage system 250. In some embodiments, network 245 may utilize different types of communication structures such as PCI, PCI-X, PCIe, other parallel bus structures, and high speed serial interface communication paths or the like to facilitate communication between the storage system 250 and the host computer 210.

Storage system 250 includes a host interface logic 248, IO Processor Subsystem 252, memory 254, drive interface 258 and arbiter 260. A bus 262 is configured to couple the host interface logic 248, IO Processor subsystem 252, drive interface 258 and arbiter 260. The arbiter 260 manages the communication between the host interface logic 248, IO Processor subsystem 252 and drive interface 258 over the bus 262.

The host interface logic 248 couples to the network 245 so as to send and receive commands and data over the network 245. The IO Processor Subsystem 252 receives the commands from the host computer 210 via the host interface logic 248 and processes the commands. In one embodiment, the IO Processor Subsystem 252 includes one or more processors, registers and local memory to perform various functions. The memory 254 is used by the IO Processor Subsystem 252 to temporarily store the packets received from the host computer 110 and the disk array 246.

The drive interface 258 is configured to receive commands from the IO Processor subsystem 252 and communicate with the disk array 246 over the link 264. In some embodiments of the disclosure, the storage space implemented by disk arrays 246 of FIG. 2 may be aggregated into a storage pool of storage space. For example, a set of disk drives from the disk arrays 246 may form a shared storage pool for a number (n) of logical volumes. Further, a subset of drives in the disk arrays 246 may form a redundant array of inexpensive disks (RAID), e.g., with a specified RAID level. Also, in some embodiments, SATA drives may be used to implement massive storage the reliability of which may be kept in check by a RAID implementation.

In use, applications executing on host computer 210, or on one or more client computers coupled to host computer 210, may consume storage resources provided by storage system 250. For example, application I/O requests may be passed from an application 222 executing in the user space 220 of the operating system to the kernel I/O driver stack, and finally through the HBA (Host Bus Adapter) 242 and network 245 to the storage system 250. In some embodiments, access to the storage resources may be controlled by using access control mechanisms. For example, user authentication mechanisms may be used before providing access to certain resources on the storage system. User authentication may involve receiving password and the likes from the user, inputted using input devices like keyboards.

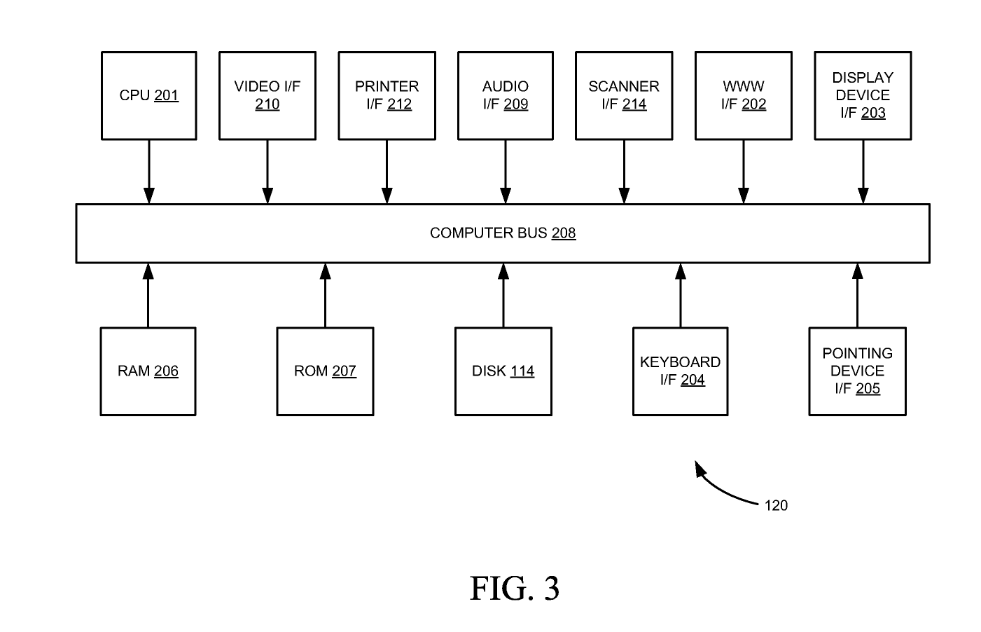

FIG. 3 is a block diagram showing the internal functional architecture of system hardware 120. As shown in FIG. 2, system hardware 120 includes a central processing unit (CPU) 201 for executing computer-executable process steps and interfaces with a computer bus 208. Also shown in FIG. 2 are a WWW interface 202, a display device interface 203, a keyboard interface 204, a pointing device interface 205, an audio interface 209, video interface 210, printer interface 212, and a disk 124. Audio Interface 209 allows a listener to listen to music, Online (downloaded using the Internet or a private network) or offline (using a CD).

As described above, disk 124 may store operating system program files, application program files, web browsers, and other files. Some of these files are stored on disk 124 using an installation program. For example, CPU 201 executes computer-executable process steps of an installation program so that CPU 201 can properly execute the application program.

A random access main memory (“RAM”) 206 also interfaces to computer bus 208 to provide CPU 201 with access to memory storage. When executing stored computer-executable process steps from disk 124 (or other storage device such as storage device 126 or Internet connection 128), CPU 201 stores and executes the process steps out of RAM 206.

Read only memory (“ROM”) 207 is provided to store invariant instruction sequences such as start-up instruction sequences or basic input/output operating system (BIOS) sequences for operation of keyboard through the keyboard interface 204.

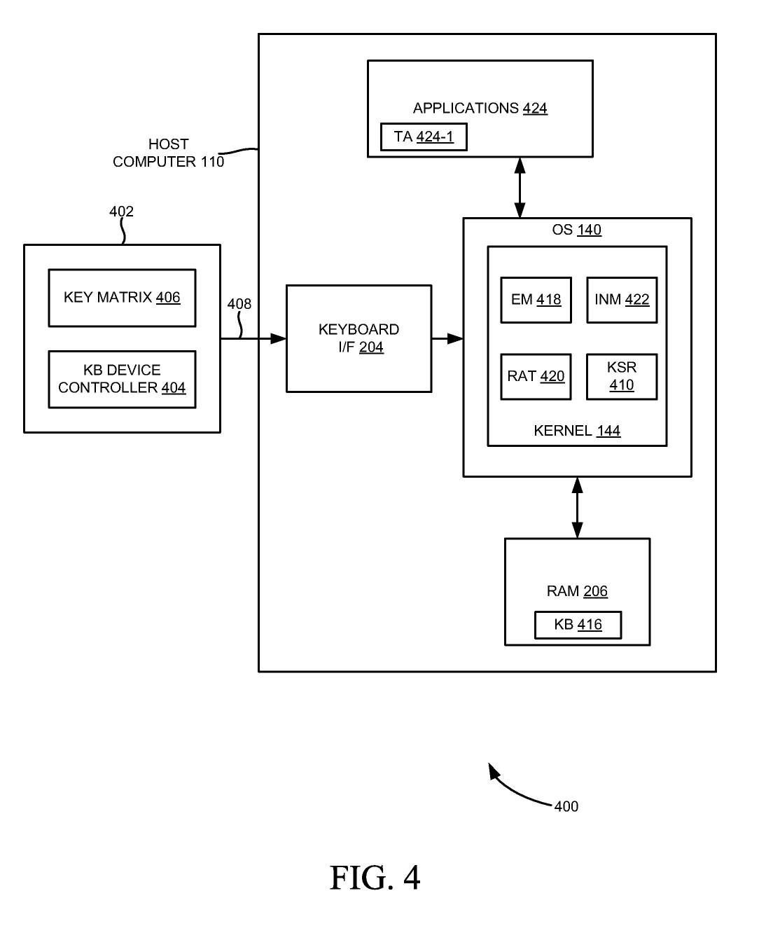

Referring to FIG. 4, an exemplary block diagram 400 showing the processing of key-strokes of a keyboard 402 by the host computer 110 according to an embodiment of this disclosure is described. The keyboard 402 includes a keyboard device controller 404, which periodically scans the key matrix 406 of the keyboard 402 for key-press. When a key of the keyboard 402 is pressed, the key board device controller 404 detects the key-press and determines a scan code of that key, from the position of key in the key matrix 406. The scan code represents the key position in the key matrix 406. The keyboard device controller 404 clocks the scan code into the keyboard interface 204.

When the keyboard interface 204 has received the key stroke data over signal lines 408 from the keyboard 402, it generates a hardware interrupt to start a keyboard service routine. When the computer processor (not shown) gets the hardware interrupt signal, the computer runs the interrupt handling routine to find out the interrupt number that caused the interrupt. The interrupt routine then uses the interrupt number to find the vector, from the interrupt vector table that points to the start of the keyboard service routine 410 that processes the interrupt. In one embodiment, the keyboard service routine 410 is executed in the kernel module 144 of the operating system 140.

The keyboard service routine 410 takes the scan code from the keyboard interface 204 and converts the scan code into a converted code that corresponds to the key-press. The keyboard service routine 410 then stores the converted code in the keyboard buffer 416 in RAM memory 206. In one embodiment, the keyboard service routine 410 invokes an encryption module 418 to encrypt the converted code that corresponds to the key-press. Then, the encrypted converted code is stored in the keyboard buffer 416. The detailed operation to encrypt the converted code will be described later.

The kernel module 144 maintains a registered application table 420 that consists of all the applications that are registered with the kernel module 144 to receive notification from the kernel module 144 if a particular type of interrupt is received. The kernel module 144 executes an interrupt notification module 422 that looks up the registered application table 420 for applications 424 that have registered for keyboard interrupt. In one embodiment, the registered application table 420 includes process identification number for the applications 424 that have registered for keyboard interrupt.

The kernel module 144 then notifies all the applications 424 registered for keyboard interrupts that a keyboard interrupt was processed. For example, the kernel module 144 uses the process identification number to notify all the applications 424 registered for keyboard interrupt.

The registered applications 424 then retrieve the stored data in the keyboard buffer 416. In one embodiment, the registered applications 424 retrieve the encrypted converted code stored in the keyboard buffer 416.

In one embodiment, one of the applications 424, for example, target application 424-1 sends a request to the kernel module 144 to encrypt the converted code, before storing the converted code in the keyboard buffer 416. In one embodiment, this request may be communicated to the kernel module 144 by requesting the kernel module to switch to a different mode, for example, safe mode, while servicing the key stroke interrupt. The kernel module 144 then communicates the request to switch to safe mode to the encryption module 418. The encryption module 418 then generates an encryption keystring to be used for the encryption of the converted code. The encryption module 418 also generates a corresponding decryption keystring to be used to decrypt the encrypted converted code. The decryption keystring is sent to the target application 424-1. In one embodiment, the kernel module 144 receives the decryption keystring and communicates the decryption keystring to the target application 424-1. In some embodiments, the encryption keystring and decryption keystring may be same.

In one embodiment, the encryption module 418 generates unique encryption/decryption keystring combination for each received request to switch to safe mode. For example, the unique encryption/decryption keystring combination may be generated using one or more unique parameters of the received request to switch to safe mode. In one embodiment, the unique parameter may be the timestamp of the request. As one skilled in the art appreciates, other unique parameters like an address of the address space allocated to an application (for example, starting, ending or an offset from the starting address may be used) or process identification number assigned to the application may be used. One of the benefits of generating unique encryption/decryption keystring combination for each request is to prevent applications other than the target application 424-1 from knowing the decryption keystring to decrypt the encrypted converted code in the keyboard buffer 416.

For example, target application 424-1 may request the kernel module 144 to switch to safe mode. The kernel module 144 communicates the decryption keystring to the target application 424-1. Based on the request to switch to safe mode, the keyboard service routine 410 invokes the encryption module 418 to encrypt the converted code that corresponds to the key-press. The encryption module 418 uses the previously generated encryption keystring to encrypt the converted code. Then, the encrypted converted code is stored in the keyboard buffer 416.The kernel module 144 then notifies all the applications 424 registered for keyboard interrupts that a keyboard interrupt was processed. For example, the kernel module 144 uses the process identification number to notify all the applications 424 registered for keyboard interrupt.

The registered applications 424 then retrieve the stored data in the keyboard buffer 416. In one embodiment, the registered applications 424 retrieve the encrypted converted code stored in the keyboard buffer 416. As only target application 424-1 knows the decryption keystring, the target application 424-1 decrypts the encrypted converted code. All other applications will be unable to ascertain the actual converted code.

Example Implementation

An example implementation will now be described, using pseudo-code. This implementation may be applicable to Unix operating system with 32 bit unsigned integer time stamp (T), although one skilled in the art may suitably modify the example for implementation in other operating systems. Additionally, other parameters other than time stamp (T) may be used.

An example request command a target application sends to request safe mode may be

Int switchKernelMode(boolean safe, String initialKey);
In the above command,
“safe”=true implies kernel needs to be switched to safe mode
“safe”=false implies kernel needs to be switched to normal mode
“initialKey” is a string chosen and sent by the target application to generate the encryption/decryption keyString. Preferably, the “initialKey” is a multiple of 4 characters, with each character of 8 bits.

Exemplary algorithm to generate keyString
Initially, make sure that the number of characters in “initialKey” is a multiple of 4. If not, append dummy characters to make the number of characters to be multiple of 4.
String[ ] subKeys;
Each subKey[i] should be 32-bits (i.e. size of the timestamp T) or 4 characters of 8 bits each.
Now, XOR individually, all the subKeys with timestamp, T.
For i=0 to subKeys.length

subKeys[i]=subKeys[i] (XOR)T;
String keyString is a combination of all these subKeys. That is
For i=0 to subKeys.length

keyString.append(subKeys[i]);
This generated keyString is sent to the target application that requested kernel mode to be switched to safe mode.

Exemplary algorithm for encryption and decryption:
In the pseudo code below, characterCount indicates ‘n’th character received from the keyboard, after the start of the kernel safe mode session.
Initialize characterCount=0;
A key-press is detected by the Kernel.
currentCharacter=getKeypressChar( );
characterCount++;
currentPosition=characterCount MOD (number of characters in keyString);
encryptedCharacter=currentCharacter XOR keystring.getCharAt(currentPosition);
Place the encryptedCharacter in the keyboard buffer. Then, the Kernel notifies all the registered applications that key-press has occurred.
The target application that requested safe mode will have the keyString to decipher the encrypted character. The target application will also have a currentCharacter count and uses this with the keyString to decrypt the encrypted character. Exemplary pseudo-code for decryption at the target application is as follows:
Initialize characterCount=0;
encryptedCharFromkernel=getCharFromBuffer( );
charactercount++;
currentPosition=characteCount MOD (number of characters in keyString);
actualCharacter=encryptedCharFromKernel XOR
keyString.getCharAt(currentPosition);

Now, referring to FIG. 4, a method for secure exchange of information in a computing system is described.

In block S500, a request to switch to safe mode is received by the computing device from a target application. For example, target application 424-1 may send a request to the computing system 110 to switch to safe mode. As an example, the request is received by the kernel module 144 of the operating system 140.

In block S502, encryption/decryption keystring is generated. For example, an encryption/decryption keystring is generated by the encryption module 418. In one embodiment, the request includes an initialKey and a time stamp T. The initialKey and time stamp T is manipulated together to generate an encryption/decryption keystring. In one embodiment, the encryption keystring and decryption keystring are same.

In block S504, the decryption keystring is sent as a response to the target application. For example, the kernel module 144 sends the decryption keystring to the target application 424-1.

In block S506, received keystroke from the keyboard is encrypted using the encryption keystring. For example, the converted code by the keyboard service routine 410 is encrypted using the encryption keystring.

In block S508, the encrypted key-stroke is stored in a keyboard buffer. For example, the encrypted converted code is stored in the keyboard biffer 416.

In block S510, applications are notified of stored key-stroke in the keyboard buffer. For example, the kernel module 144 refers to the registered application table 420 to identify applications 424 that have registered for notification of key-stroke events. Using the corresponding process identification number, the kernel module 144 notifies the registered application of key-stroke event. The target application 424-1 is also notified.

In block S512, the target application retrieves the encrypted key-stroke. For example, the target application 424-1 retrieves the stored encrypted converted code from the keyboard buffer 416.

In block S514, the target application decrypts the encrypted key-stroke using the decryption keystring. In one embodiment, after receiving all the characters in safe mode, the target application sends another request to terminate the safe mode. The kernel module 144 then switched from the safe mode to normal mode of operation. Under normal mode of operation, the converted code is not encrypted.

The present invention may also include a computer product which may be a storage medium including instructions which can be used to program a computing device to perform a process in accordance with the present invention. The storage medium can include, but is not limited to, any type of disk including floppy disk, optical disk, CD-ROM, magneto-optical disks, ROMS, RAMs, EPROMs, EEPROMS, flash memory, magnetic or optical cards, or any type of media suitable for storing electronic instructions.

As one skilled in the art appreciates, system and methods of this disclosure may be used for securely exchanging information between an application and a user input device. As an example, any dialogue between an application and a user input device may be protected from unauthorized access or compromise by other applications, for example, keyloggers and other malicious software applications. In some embodiments, the system and methods may be used by management console applications, for example, a storage system or a network system management console applications. In some applications the system and methods disclosed may be used for authentication dialog between an application and a user input device. In some other applications, the system and methods disclosed may be used for secure exchange of any information considered sensitive.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., complementary metal-oxide-semiconductor (CMOS) based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated circuit (ASIC)).

What is claimed is:

1. A method for secure exchange of information in a computing system, comprising:
receiving a request to switch to a safe mode from a target application;
generating encryption/decryption keystring based on the request;
responding to the target application with the decryption keystring;
encrypting a key-stroke using the encryption keystring;
storing the encrypted key-stroke in a keyboard buffer;
retrieving the encrypted key-stroke by the target application; and
decrypting the encrypted key-stroke using the decryption keystring by the target application.

2. The method of claim 1, further comprising maintaining a list of applications registered to be notified of key-stroke event and notifying the registered applications of stored key-stroke in the keyboard buffer.

3. The method of claim 1, wherein receiving a request to switch to a safe mode includes providing an initial keystring by the target application.

4. The method of claim 3, wherein generating encryption/decryption keystring includes manipulating initial keystring with a parameter associated with the request to derive the encryption/decryption keystring.

5. The method of claim 4, wherein the parameter associated with the request is a time stamp of the request.

6. The method of claim 1, further comprising receiving a request to terminate safe mode from the target application.

7. A system for secure exchange of information in a computing system, comprising:
a kernel module configured to
receive a request to switch to a safe mode from a target application;
generate encryption/decryption keystring based on the received request;
respond to the target application with the decryption keystring;
encrypt a key-stroke using the encryption keystring; and
store the encrypted key-stroke in a keyboard buffer; and
the target application configured to
retrieve the encrypted key-stroke from the keyboard buffer; and
decrypt the encrypted key-stroke using the decryption keystring.

8. The system of claim 7, wherein the kernel module maintains a list of applications registered to be notified of a key-stroke event and notifies the registered applications of stored key-stroke in the keyboard buffer.

9. The system of claim 7, wherein the request to switch to a safe mode includes an initial keystring provided by the target application.

10. The system of claim 7, wherein the initial keystring is manipulated with a parameter associated with the request to derive the encryption/decryption keystring.

11. The system of claim 10, wherein the parameter associated with the request is a time stamp of the request.

12. A non-transitory computer readable storage medium for secure exchange of information in a computing system, the storage medium having instructions that, when executed by a computing device causes the computing device to perform the method as claimed in claim 1.
